(19) United States
(12) Patent Application Publication
(10) Pub. No.: US 2003/0030731 A1
(43) Pub. Date: Feb. 13, 2003

(54) System and method for transferring image data between digital cameras

(76) Inventor: Steven M. Colby, Santa Clara, CA (US)

Correspondence Address: Steven M. Colby, P.O. Box 52033, Palo Alto, CA, 94303, US

(21) Appl. No.: 10/208,075

(22) Filed: Jul. 29, 2002

Related U.S. Application Data
(63) Continuation-in-part of application No. 10/137,540, filed on May 1, 2002.
(60) Provisional application No. 60/288,710, filed on May 3, 2001.
(60) Provisional application No. 60/308,140, filed on Jul. 27, 2001.

(51) Int. Cl. H04N 5/225

(52) U.S. Cl. 348/231.3; 348/231.7

(57) ABSTRACT

A digital camera and image processing system configured for transferring image data. Transferring means including wireless transmission, transmission through a telephone network, and copying image data to detachable memory modules. Recorded images are optionally previewed and selected for transmission prior to actual transmission. Wireless transmission may be through a cellular telephone network and may be to an internet-based image processing system configured to process digital images and optionally delivery them to a client. The digital camera optionally receives data from an internet based image processing system and/or from other digital cameras. In addition to image data transmission optionally includes processing preference data, user identifying data, and address data.

### CROSS-REFERENCE TO RELATED APPLICATIONS

This application claims benefit of commonly owned U.S. Provisional Patent Application No. 60/288,710 entitled “System and method for downloading image data from a digital camera,” filed May 3, 2001 and U.S. Provisional Patent Application No. 60,308,140 entitled “Camera to camera data transfer,” filed Jul. 27, 2001. The disclosures of these two provisional patent applications are incorporated herein by reference.

This application is a continuation-in-part of U.S. Non-provisional Patent Application Ser. No. 10/137,540, entitled “System and Method for Transferring Image Data From a Digital Camera” filed May 1, 2002, the disclosure of which is incorporated herein by reference.

### BACKGROUND

1. Field of the Invention

The invention is in the field of digital cameras and specifically in the field of transferring data from one digital camera to another digital camera or memory.

2. Description of the Related Art

In portable digital cameras images are received by an photosensitive transducer producing image data that is stored in memory. The memory can be RAM or SRAM permanently connected to the camera or removable media such as a floppy disk, compact disk, or SRAM module. Most portable digital cameras allow a user to preview and delete images. Preview and deletion allows users to keep only images of interest and to conserve the limited available memory for preferred images. Despite this feature, there is a limit to the number and quality of images that portable digital cameras can hold. It is, therefore, necessary to download these images to a computing device to export them from the camera and view them through other means such as a computer screen or hardcopy. Downloading typically occurs either through a physical connection between the camera and a computer or through transfer of removable media to a reader associated with a computing device. These computers are generally not portable, or less portable than the camera, and are not conveniently in proximity to the camera or removable media.

It would be desirable to transfer image data from one digital camera to another digital camera. However, in the prior art the ability to transfer data from one digital camera to another digital camera is limited. Likewise, there are no systems available for directly copying image data from one detachable image memory module to another image memory module.

### BRIEF SUMMARY OF THE INVENTION

Embodiments of the invention include systems and method of transferring data from one digital camera to another digital camera or an image processing system. Transfers may take place through a wireless, electronic, or optical means and may also be directly between digital cameras or through an image processing system. Various embodiments of the invention also include a digital camera with a plurality of memory modules one or more of which is detachable. Some embodiments include controls for copying image data from one of the memory modules to another of the memory modules using the digital camera. These systems may be used to copy image data. The detachable memory module may be used to convey image data to another digital camera or an image processing system.

Some embodiments include an image transfer system comprising a digital camera including a first memory module and a memory receiver configured to receive a second detachable memory module, and means for transferring image data between the first memory module and the second memory module.

Some embodiments include an image processing system comprising a microprocessor, a memory receiver configured to receive a memory for storing image data; and digital data storage, the image processing system configured to receive the image data from the memory, associate the image data with a user using user identification data, and process the image data using the microprocessor and preferred image processing preferences.

Some embodiments include a method of processing an image comprising the steps of 1) recording image data using a digital camera, 2) saving the image data to memory attached to the digital camera, 3) detaching the memory from the digital camera, 4) conveying the memory to an image processing system including a digital data storage, 5) attaching the memory to the image processing system, 6) transferring the image data from the memory to the digital storage, 7) associating the image data with a user, and 8) processing the image data according to preferred image processing preferences.

Some embodiments include an image transfer system comprising a first digital camera including a wireless transmitter configured to transmit image data and including controls configured to select the image data from a plurality of image data and to initiate the transfer of the image data, and a second digital camera including a wireless receiver configured to receive and display the image data.

Some embodiments include a method of producing a digital image, the method comprising the steps of 1) recording image data using a first digital camera, 2) viewing the recorded image data on a display connected to the first digital camera, 3) selecting the image data, from among a plurality of image data, for transmission from the first digital camera, 4) entering address data into the first digital camera, 5) transmitting the selected image data using a wireless transmitter and the address data, 6) receiving the selected image data at a second digital camera using a wireless receiver, and 7) displaying the received image data at the second digital camera.

Some embodiments include a method of transferring image data comprising the steps of 1) recording image data using a first digital camera including a display, 2) setting the first digital camera in a transmission mode, 3) viewing the image data using the display, 4) selecting a viewed image data for transfer, 5) setting a second digital camera in a receive mode, 6) establishing a communication means between the first digital camera and the second digital camera, and 7) executing a transfer of the selected image from the first digital camera to the second digital camera using the established electronic communication means.

Some embodiments include a system for transferring image data, the system comprising a first digital camera including camera controls, a display and a transmission mode, the first digital camera configured to record image data, view the recorded image data using the display, select a viewed image for transfer using the camera controls, and transfer the image data using the transmission mode; a second digital camera including a receive mode and a receiver configured to receive the image data using the receive mode; and means for transfer the digital data between the first digital camera and the second digital camera.

Some embodiments include a system of transferring image data comprising a first detachable memory module configured to store image data; and a digital camera including a second memory module configured to store image data, a memory receiver configured to receive the first detachable memory module, camera controls configured to select image data for transfer between the first detachable memory module and the second memory module and to initiate the transfer, and a display configured to view image data stored in the first detachable memory module or the second memory module.

Some embodiments include method of copying image data comprising the steps of 1) recording image data using a digital camera, the digital camera including a plurality of memory configured to store then image, at least one of the plurality of memory being separable from the digital camera, 2) viewing the image data using a display coupled to the digital camera, 3) selecting the viewed image data for transfer from a first member of the plurality of memory to a second member of the plurality of memory, and 4) operating controls to initiate the transfer of the selected image data from the first member of the plurality of memory to the second member of the plurality of memory.

Some embodiments of the invention include a method of copying image data comprising the steps of 1) saving image data in a first detachable memory module, 2) attaching the detachable memory module to a digital camera, the digital camera including a second memory module configured to store the image data, and 3) operating camera controls to initiate the transfer of the image data from the first detachable memory module to the second memory module.

### BRIEF DESCRIPTION OF THE SEVERAL VIEWS OF THE DRAWINGS

FIG. 1 is a block diagram of an embodiment of the invention;

FIG. 2 is a block diagram of an alternative embodiment of the invention that includes a memory receiver;

FIG. 3 is a block diagram of an alternative embodiment of the invention in which a modem facilitates a connection to a communications network;

FIG. 4 is an illustration of a method of the invention through which images are recorded, transmitted, and processed;

FIG. 5 is an illustration of a method of the invention through which a user accesses a processing system through a client;

FIG. 6 is an illustration of a method of the invention employing the system illustrated in FIG. 2;

FIG. 7 is a block diagram of elements that can be included in a memory;

FIG. 8 is a block diagram of an alternative embodiment of the invention;

FIG. 9 illustrates an embodiment of the invention including a transmitting digital camera configured to transfer data to a second digital camera;

FIG. 10 illustrates transmitting digital camera and receiving digital camera;

FIG. 11 illustrates embodiments of first digital camera and a second digital camera each including a built in connector configured to serve the functions of a communications means;

FIG. 12 illustrates an embodiment of a method of the invention in which data is transferred from a digital camera to a second digital camera;

FIG. 13 illustrates an alternative embodiment of the invention including a digital camera; and

FIG. 14 illustrates a method of the invention using the embodiment of the invention wherein the digital camera illustrated in FIG. 13 serves the function of an image transfer or copying device.

### DETAILED DESCRIPTION OF THE INVENTION

The invention includes a portable camera with optional wireless communications means such as a built in wireless transmission unit, a connection to an independent wireless transmission device such as a wireless (cellular or cordless) telephone, an independent wireless transmitter or the like. Embodiments of the invention also includes receiving, storage, and processing systems for accepting the transmitted image, storing transmitted image t in a manner accessible to a user, and enabling redisplay of the image. Image transmission can include conveying the image data over telephone and computer networks.

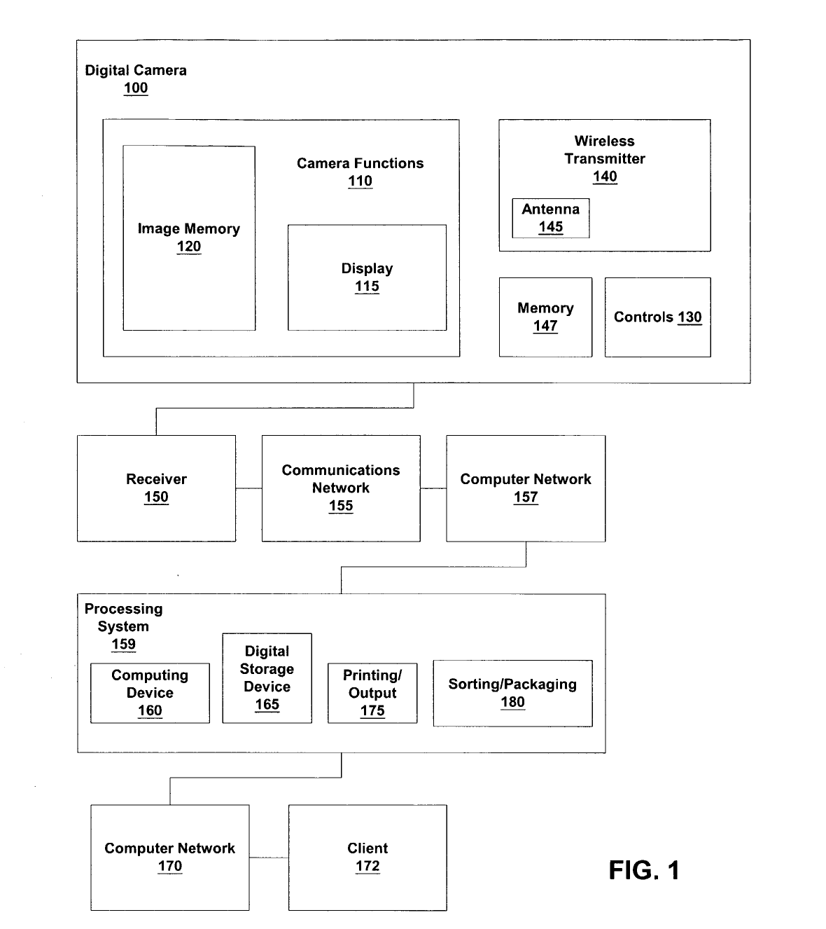

FIG. 1 illustrates an embodiment of the invention, including a digital camera 100. Digital camera 100 further includes camera functions 110 such as optics and a photosensitive transducer. Camera functions 110 can include any feature available in prior art digital cameras such as a power source and image memory 120 for the storage of digital images. Image memory 120 can be RAM, SRAM, magnetic or optical media, or the like. In some embodiments image memory 120 is detachable. Camera functions 110 also include an image display 115 for viewing images to be recorded or images already recorded. Image display 115 optionally serves as a viewfinder and can be used to select images for deletion or transmission. Image display 115 is optionally a viewfinder optic that a user employs to see what is being recorded.

Embodiments of digital camera 100 include a wireless transmitter 140. Wireless transmitter 140 is optionally incorporated, at least in part, within the body of digital camera 100 and optionally includes an antenna 145 or an attachment point for a detachable antenna 145. Alternatively, wireless transmitter 140 is a unit independent from digital camera 100 configured to be coupled to digital camera 100 by electronic or optical means. In one embodiment, wireless transmitter 140 is a cellular telephone coupled to digital camera 100 via a cable. In one embodiment, wireless transmitter 140 plugs directly into digital camera 100. Wireless transmitter 140 transmits at visible, radio, microwave, or infrared frequencies. Digital camera 100 is preferably, but not necessarily, handheld.

In an embodiment of the invention, a user may manipulate a recorded image, and the associated image data, in at least three ways. These include an optional “save” option and a “delete” option, as typically found in the prior art. This embodiment also includes “transmit” and “mark” options. Controls 130 enable the selection of at least the delete and transmit options and optionally the save and mark options. These options for manipulating image data may be executed one image at a time or, alternatively, controls 130 may be used to “mark” a plurality of images for bulk manipulation of images and associated image data.

Controls 130 also optionally provide means for a variety of data input and programming of camera 100, including entering data such as preferred image processing preferences data 730, user identifying data 710, address data 720, or the like. Transmission optionally occurs in the background, such that other functions of the camera operate normally during transmission. Recording of images can occur during transmission of images. When a transmission is complete, and optionally acknowledged, the image data is optionally removed from memory 120 so that memory 120 can be used for other purposes such as recording or storing new images. In one embodiment removal of image data from memory 120 after the transmission of the image data is automatic. In one embodiment memory 120 is a Sony™ Memory Stick.

Wireless transmitter 140 is configured to send, and optionally receive, image data and can also send or receive additional optional information such as a serial number of digital camera 100, an account or user identification number, caller I.D. associated with a telephone number, a telephone number, an address, user account data, data conveying instructions regarding desired processing of the image data after it is received, or any other data stored in camera 100. A telephone number can be used to identify a user or digital camera 100 in embodiments wherein each user or digital camera 100 use different telephone numbers.

The transmission from wireless transmitter 140 is received by a receiver 150 associated with an optional communications network 155. In an embodiment communications network 155 is a telephone network and the transmission from digital camera 100 includes a telephone number for opening a communication channel to a specific destination on communications network 155. Receiver 150 and communications network 155 can be coupled to an optional computer network 157 or directly to image processing system 159. Computer network 157 is optionally the World Wide Web.

Image processing system 159 includes a computing device 160, a digital storage device 165, an optional printing/output 175 device, and an optional sorting/packaging device 180. Computing device 160 includes an a processor for executing software or firmware instructions. Computing device 160 is a computer, server, personal digital assistant, digital camera 100, or the like. Computing device 160 receives images delivered from digital camera 100 through receiver 150 and identifies their source using user identifying data included in the transmission. These user identity data optionally include caller ID number, user account number, address data, a telephone number, camera ID number, or any other user identifying data. User identifying data is used to associated a user with image data. A caller ID can be used as user identifying data 710, while a telephone number (called) can be used as both identifying data 710 and address data 720. After transmission, computing device 160 stores the image data on digital storage device 165. Digital storage is a digital memory device such as a hard disk, and optical disk, magnetic memory, ROM, SRAM, RAM, or the like. The location of the storage and access to the stored data is optionally associated with a user account. Digital storage device 165 can include user account information and meta-language data, and can be accessible through an optional computer network 170 such as the World Wide Web. Computer network 170 optionally shares components with computer network 157. Computer network 170 is accessible using optional client 172. Image data can be transferred between digital storage system 165 and client 172. Client 172 is configured to communicate with processing system 159 through computer network 170. Client 172 can, for example, be a digital camera, such as another digital camera 100; a computing device, such as a PDA, a personal computer, a server, or a programmable telephone; or the like. Data transfer optionally uses an internet browser running on client 172. Access to data on storage system 165 is optionally controlled by password. Different passwords can allow different views of the account such as only read access or read/write access. The data on storage system 165 is optionally accessible using a universal resource locator (URL). In one embodiment of the invention, image processing system 159 includes a printing/output 175 system for generating copies of images. Physical copies are handled by sorting/packaging 180 and shipping means. Data sent by wireless transmitter 140 can include preferred image processing preferences data such as instruction on desired printing/output 175, print size, delivery location, print quality, handling of copies, and the like. Alternatively, such instruction is provided from client 172 through network 170 and stored on digital storage device 165 in connection with user account data. Copies are typically either physical hardcopies, data recorded on storage media, or projections of an image.

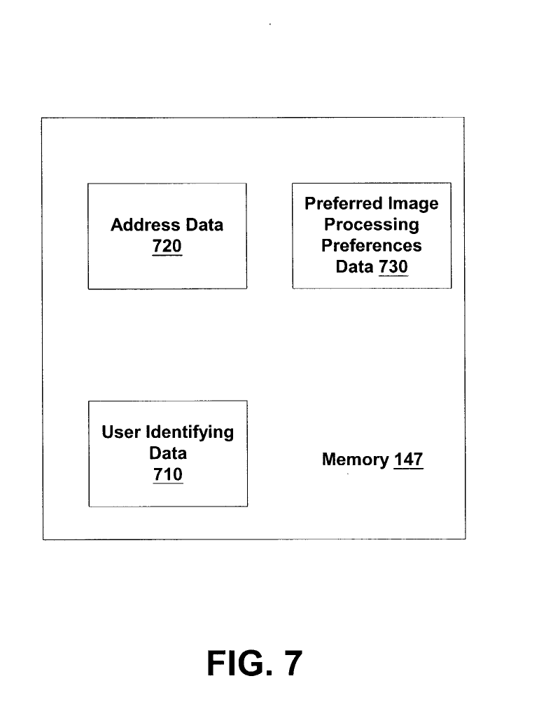

Digital camera 100 optionally includes Memory 147. As illustrated by FIG. 7, memory 147 is configured to store one or more elements of non-image data such as user identifying data 710, address data 720, and preferred image processing preference data 730. Address data 720 includes address information related to processing system 159 and/or includes user address information for delivering of output. For example, in various embodiments, address data 720 includes a telephone number, internet protocol address, universal resource locator for processing system 159, an e-mail address, account directory for a user, a physical address, or similar locating information. A physical address can include a street address, an identifier for a physical location such as a store number (Safeway #207), or the like. User identifying data 710 includes a caller ID number, a camera ID number, a telephone number, address data 720, a user name, and/or any similar identifying data. User identifying data 710 is used to associate a camera, user, or user account data with image data after image data is removed from digital camera 100. In one embodiment of the invention, data, such as user identifying data 710, address data 720, or preferred image processing preference data 730, within memory 147 is automatically combined or associated with image data before transmission.

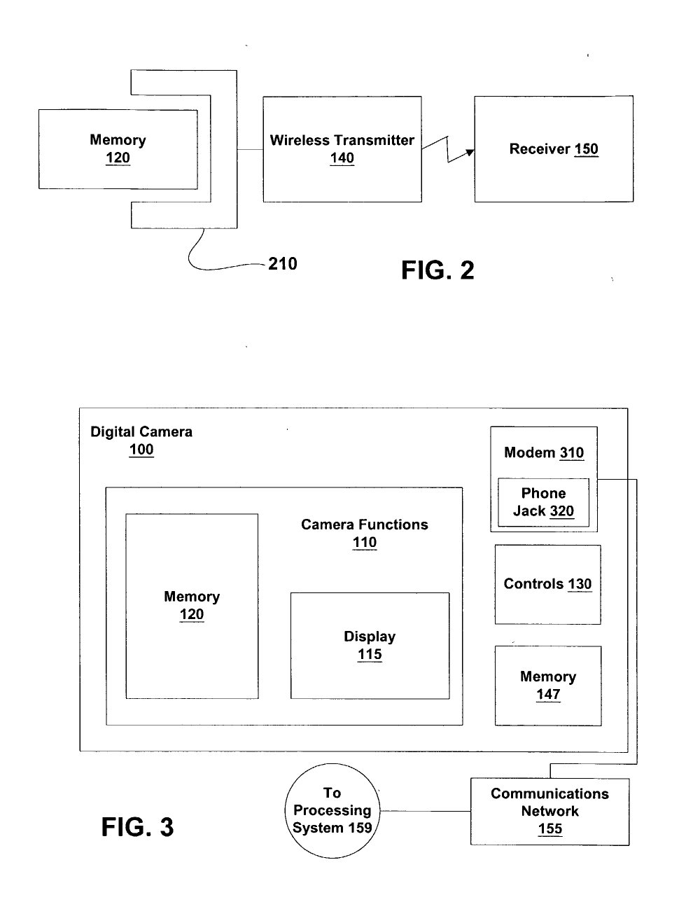

FIG. 2 illustrates alternative embodiments in which wireless transmitter 140 is not directly coupled to digital camera 100. In these embodiments, wireless transmitter 140 is configured to be coupled to a memory receiver 210 which, in turn, is configured to mate with detachable memory 120. Images recorded with digital camera 100 are saved to memory 120. Memory 120 is then removed from digital camera 100 and coupled to memory receiver 210. Memory receiver 210 reads the data in detachable memory 120 and transfers the data to wireless transmitter 140. The data transferred can include information, such as a serial number of memory receiver 210, other data stored in memory 147, or the like, in addition to image data. Wireless transmitter 140 then transmits the included data to receiver 150 and the data is further managed as describe in the discussion of FIG. 1 and elsewhere herein. Memory receiver 210 and wireless transmitter 140 are included in the same device or, alternatively, separate devices electronically or optically coupled. For example, they can be coupled by a cable. In an embodiment, memory receiver 210 or wireless transmitter 140 includes memory 147 and the data associated therewith. In one embodiment, wireless transmitter 140 is a cellular telephone and memory receiver 210 is configured to couple to a prior art I/O port found on most cellular telephones. In this embodiment, wireless transmitter 149 optionally includes memory 147 containing data used for dialing the cellular telephone.

FIG. 3 illustrates alternative embodiments in which wireless transmitter 140 is replaced by modem 310. Modem 310 is coupled to communications network 155 which, in this embodiment, is possibly the public telephone system and is thereby able to perform some functions of wireless transmitter 140 without the use of wireless connections. Modem 310 includes phone jack 320 (male or female) for direct connection to a telephone system. In one embodiment of the invention, modem 310 is wireless and therefore functions as wireless transmitter 140. For example, in the embodiments illustrated by FIG. 2, wireless transmitter 140 can alternatively be replaced by modem 310. Memory receiver 210 or transmitter 140 optionally include controls 130. In all other embodiments the system illustrated in FIG. 3 is capable of operating in manners identical to the embodiments discussed in association with FIGS. 1 and 2. In embodiments incorporating either modem 310 or wireless transmitter 140, digital camera 100 is considered “remotely downloadable.” Modem 310 is optionally a wireless modem. In one embodiment wireless transmitter 140 is a wireless Ethernet card configured for communication with a local or wide area network.

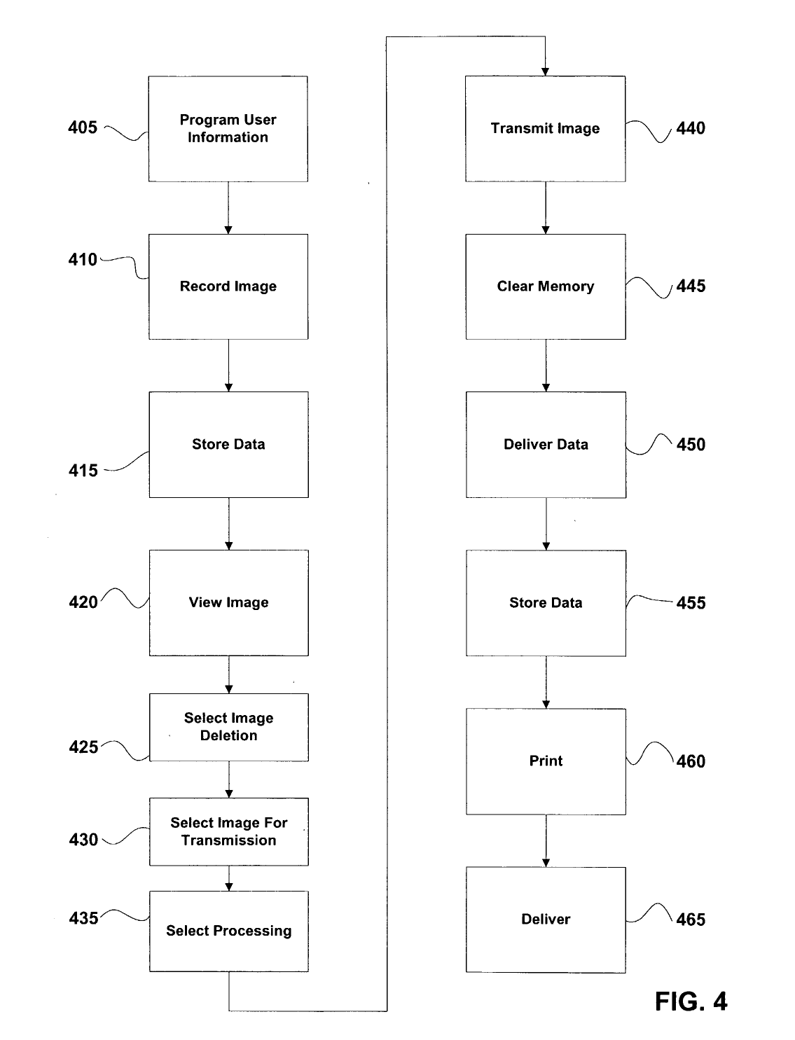

FIG. 4 illustrates a method of various embodiments of the invention. In an optional step 405 user information is programmed into memory 147. This information includes data, such as an account number, caller identification, or serial number, name, or the like, that is used to identify the user or camera. The information programmed in step 405 optionally includes address data for accessing processing system 159 or receiver 150. For example, the address can be a telephone number, network address, part of a universal resource locator, or the like. If the address is a telephone number, the information is optionally used to route a call through communications network 155. The information programmed in step 405 also optionally includes user preferences for processing transmitted data and management of memory 120. The information programmed is optionally changed at a later time.

In a step 410, a user employs camera functions 110 to record an image (image data) and in a step 415 the resulting image data is stored in memory 120. In a step 420 the user has the option of viewing the resulting image data as an image using display 115. Step 410 occurs prior to step 420. Step 420 is optionally repeated several times between steps 415 and 440. In an optional step 425 images are selected for deletion. This process clears memory and increases the amount of memory available for additional image data. Steps 410 through 425 are possible in prior art digital cameras and, in both the invention and the prior art, these steps can be executed in a variety of orders.

In a step 430 images are selected for transmission. One embodiment includes a mode of operation wherein step 430 automatically includes all available images and, thus, requires no input from the user. One embodiment includes a mode in which each image is transmitted shortly after recording. One embodiment includes a mode in which images are transmitted when available image memory drops below a predetermined value. Embodiments also include other modes of operation wherein a user marks recorded images for transmission. Marking optionally occurs during or after viewing the image in an instance of step 420. Images are optionally transmitted one at a time once they are marked or, alternatively, a plurality of marked images are sent in “bulk” in a single transmission. Marking of an image is accomplished using controls 130. The controls 130 used to mark an image may include buttons, dials, switches, touch sensitive screens, voice detection, and like input devices. Other embodiments include modes wherein images are transmitted after a predetermined number of images have been recorded, at a specific time of day, when digital camera 100 is turned on or off, or when a user executes a “transmit” command. A user can control timing of image transmission through these modes.

In an optional step 435 the user selects processing or destination options for the images to be transmitted. These options include, for example, the selection of different processing systems 159, digital storage device 165 locations, printing/output 175 options, or delivery sorting/packaging 180 options. The selected options can also include modification of the information collected in step 405. In one embodiment, step 435 includes specification of part of a URL for storage of images to be accessible through the World Wide Web. In one embodiment step 435 includes specification of a password for controlling access to images after transmission.

In a step 440 images are transferred to an address programmed in step 405 and possibly modified in step 435. The transmission of images can occur as a background process. Steps 410 through 435 can be independently executed during the execution of step 440. In one embodiment, the transmission of images occurs over a cellular telephone network compatible with wireless transmitter 140. In another embodiment the transmission of images occurs over a non-cellular telephone network. In another embodiment the transmission of images occurs by conveying memory 120 and memory 147 to processing system 159 and transferring data directly. In this embodiment processing system 159 is configured to receive image memory 120. When the transmission occurs over a telephone network, the address information stored in steps 405 or 430 optionally includes a telephone number. During the transmission, the data sent is received by receiver 150. The receiver optionally sends a confirmation indicating that the transmitted data was properly received. Image quality adjustments, compression of image data, and compression of other data can be used to modify the amount of data transmitted in step 440. In an embodiment of the invention, step 440 is performed automatically after image data is recorded in step 410.

In an optional step 445 image data within memory 120 is cleared. The image data cleared is preferably the image data that was transmitted in step 440 or a subset of that data.

In a step 450 the transmitted data is delivered to processing system 159. If processing system 159 is directly associated with receiver 150 the delivery can be direct. However, optional communications network 155 and optional computer network 157 can also be used to deliver the transmitted data. In one embodiment, receiver 150 is a cellular telephone receiver and communications network 155 is a telephone system. In this embodiment, data is transferred using a cellular compatible wireless transmitter 140 to a cellular telephone compatible receiver 150 station and then delivered to processing system 159 using telephone communications network 155. Computer network 157 is optionally involved in the transmission either before or after communications network 155.

In a step 455 transmitted data is stored by processing system 159 in digital storage device 165. This process is managed by computing device 160. Information within the transmitted data optionally determines the location of the data within digital storage device 165. For example, the information can be used to place the data within a specific directory, account, file, or the like. The information can also be used to control access rights and permissions relating to the location at which the data is stored.

In an optional step 460, a copy is made of the image data or image derived from the image data using printing/output 175. Printing/output 175 is optionally a photographic or printed hardcopy; or a digital copy. Various options, such as those typically available when reproducing images for printing, can be selected by the user. Printing can also include transfer of the data to portable storage media other than paper. For example, in one embodiment of step 460, printing/output 175 is used for writing (copying) the data to portable optical or magnetic media such as floppy disc, compact disc, video disc, magnetic tape, or similar media used to store data. Step 460 can also include the publishing of image data within network compatible meta-language files such as HTML or XML files or can include image data delivery through computer messaging systems such as e-mail. Meta-language files are created by printing/output 175 system. The image data can be published in graphics files using standard formats such as .bmp, .wmf, .gif, .tif, .jpg or the like.

In an optional step 465, the output of step 460 is delivered to a destination typically chosen by a user. This delivery optionally uses sorting/packaging 180 equipment. In various embodiments the images are sorted, packaged, and delivered via post, e-mail, HTML, package delivery or the like.

Any of steps 430 through 465 are optionally performed automatically without further input from a user. Thus, in one embodiment of the invention, once an image (image data) is stored in step 415 it is automatically transmitted to processing system 159 and then automatically delivered to a destination pre-selected by the user. For example, in one of these embodiments, as a user records images, the images are automatically delivered to an e-mail account or web page. In other embodiments, one or more of the steps following step 435 are executed automatically. If images are moving images, they can be transmitted to a file on a digital storage device 165 as they are recorded. This reduces the requirements of memory 120 for recording moving (video) images.

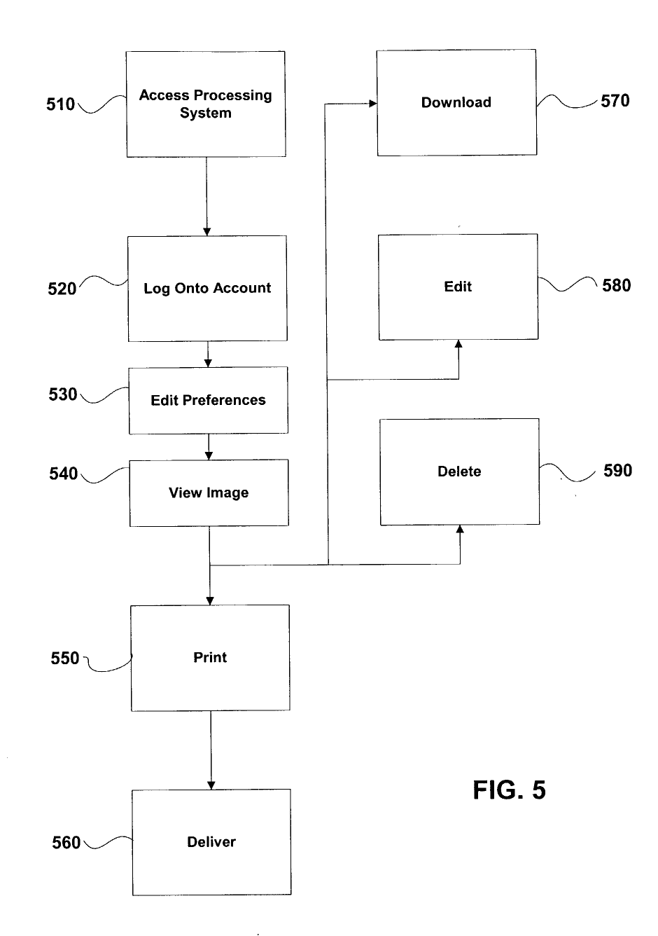

FIG. 5 illustrates an embodiment of the invention in which a user accesses processing system 159 and directs the processing of image data through client 172. Client 172 accesses processing system 159 through optional computer network 170. Computer network 170 can be the same as, or part of, computer network 157.

In a step 510, the user accesses processing system 159. This typically is through a software program, such as a browser, located on client 172. The access to processing system 159 is moderated by a computing system such as computing device 160. In an optional step 520 the user logs onto an account. This step provides a security element and determines privileges of the user.

In an optional step 530 the user edits account preferences. These preferences can include, for example, access rights and permissions relating to the data controlled by the user's account. They may also include preferred image processing preferences data 730 with instructions used to guide actions that are taken in steps 455, 460, and 465. For example, a user can specify that all images transmitted in step 440 should be stored and no other action automatically taken, that the images should be printed in the form of .jpg files and published on a web page, or that the images should be printed on photostock and delivered to the user by mail. Several forms of processing can be selected for each image. The preferences optionally include billing information such that the user can be charged for the services performed as part of the invention. Preferred image processing preferences data 730, address data 720, or user identifying data 710 is optionally transferred from processing system 159 to digital camera 100 using the same communication means by which data is transferred from digital camera 100 to processing system 159. Thus, data entered through processing system 159 can be used to program memory 147 on digital camera 100. For example, in one embodiment data is entered at client 172 transferred to processing system 159 and then to digital camera 100. In this embodiment digital camera 100 is configured to receive data, such as the types of data stored in memory 147 and image memory 120, through a wireless transmitter from an image processing system 159. Digital camera 100 is, thus, remotely programmable.

In an optional step 540 the user is given the opportunity to view the images and performing operations on each image individually or in groups. These operations include, for example, the steps of printing 550 and delivering 560 the images. Steps 550 and 560 are fundamentally identical to steps 460 and 465 except that they are specifically directed by the user after step 440. The user can choose to execute an optional download step 570 in which image data is downloaded to client 172. Since client 172 is optionally a digital camera 100, in some embodiments of the invention, the invention provides means for automatically or manually transferring an image (image data) between cameras. In one embodiment, both network 155 and computer network 170 include a cellular telephone network. In this embodiment, image data is optionally transferred by using one instance of digital camera 100 to dial a telephone number associated with another instance of digital camera 100. Dialing is optionally performed using controls 130. Image data is transferred through telephone networks, without requiring use of processing system 159, from one digital camera 100 to another digital camera 100. The user can choose to execute an optional edit step 580 in which the image is edited. An editing step 580 can, for example, include a data format conversion, cropping, removal of “redeye”, or the like. Finally, the user can choose to execute a delete step 590 in which data is deleted. Steps 540 through 580 are optionally performed in a variety of orders and at multiple times. In one embodiment, image data is transferred directly form digital camera 100 to client 172 without passing through processing system 159.

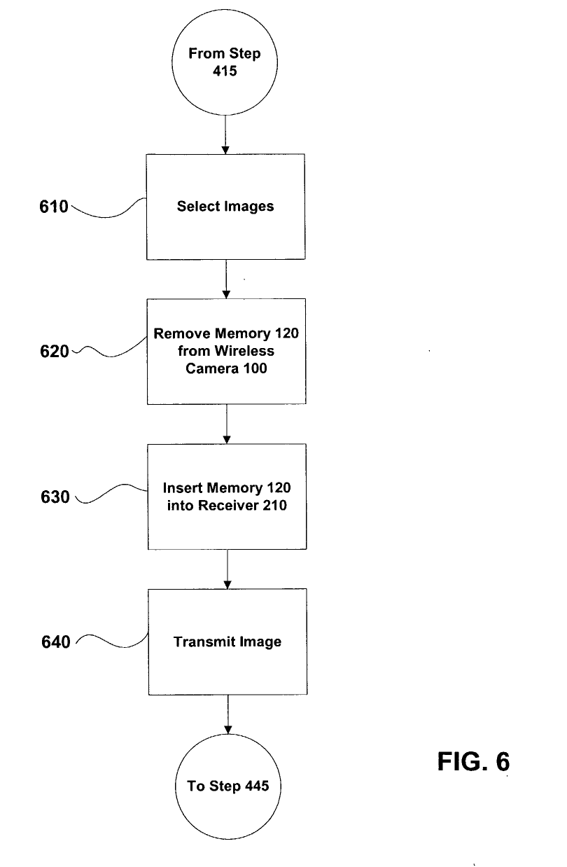

FIG. 6 illustrates additional steps performed when the apparatus illustrated in FIG. 2 is employed. In this embodiment, proceeding from step 415 of FIG. 4, images are selected in an optional image selection step 610. Image selection step 610 is similar to either step 425 or step 430 and can be performed at any time prior to step 640.

In a step 620, memory 120 is detached from digital camera 100 by a user. In a step 630, the detached memory 120 is inserted into memory receiver 210. In a step 640 the image is transmitted in a manner similar to that of step 440. The process then proceeds to step 445 of FIG. 4. Not shown are steps of returning memory 120 to digital camera 100. Steps 620 and 630 optionally include manipulation of memory 147 in a manner identical to memory 120.

Digital images manipulated by the system and method of the invention may be either still images or moving pictures such as motion video or both. Digital images optionally include an audio track.

Using the methods and systems of the invention, images in a portable digital camera can be first viewed and then transferred and saved elsewhere without the need to connect the digital camera 100 or its memory 120 to a computing device.

The transfer (transmission) of image data from digital camera 100 to processing system 159 is optionally automatic. For example, in one embodiment the transfer occurs without further input from a user whenever an image is recorded. The transfer of data optionally includes compression. Image data is optionally transferred at the same time that image data is recorded (in parallel). For example, a video camera including features of digital camera 100 can capture moving image data and store the captured data briefly in memory. In one or more parallel processes the captured data is optionally compressed into a format such as MPEG or other standard video compression format, and transmit data to processing system 159 via a cellular telephone network. The transmission process can occur as further image data is recorded.

In an alternative embodiment, both memory 120 and memory 147 are detachable from digital camera 100. Memory 120 and memory 147 are optionally a single device and can also be conveyed to processing system without the use of wireless transmitter 140 or modem 310. At processing system 159, the data in memory 120 and memory 147 is transferred to computing device 160 or digital storage device 165. In this embodiment, user identifying data 710, address data 720, or preferred image processing preferences data 730 are stored with the image data and can be accessed by a system using the image data, such as processing system 159. Controls 130 optionally include data entry means for programming memory 147 and the data therein. In this embodiment, the preferred image processing preferences data 730 and/or user address data 720 can be programmed in digital camera 100 and then automatically conveyed with the image data to the processor.

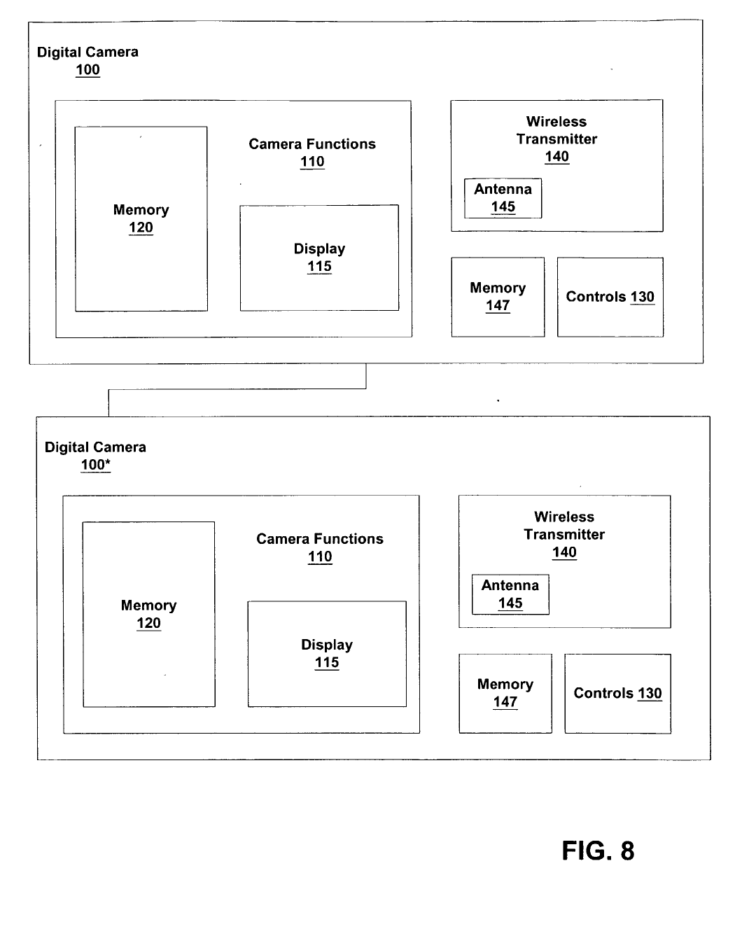

In an embodiment of the invention a first digital camera 100 is configured to transfer data (such as image data), using wireless transmitter 140 and receiver 150. Wherein, receiver 150 is coupled to a second digital camera 100. This embodiment is illustrated in FIG. 8 where the second digital camera 100 is designated “100* ”. In second digital camera 100* an instance of wireless transmitter 140 acts to serve the function of receiver 150. In various embodiments the data transferred between digital cameras 100 and 100* includes image data, any of the data stored in memory 147, or the like. Data transfer can include infrared, microwave, radio, or any other wireless communication medium. Data transfer is optionally controlled by camera functions 110. In other embodiments, that do not require wireless transmitter 140 and receiver 150, transfer of image data is accomplished through an electronic coupling. For example, through an electronic cable disposed directly between both first and second digital cameras 100 and 100*.

Address memory, address data 720, preferred image processing preferences data 730, user identifying data 710, memory 147, identifying memory, and preferences memory are each optionally also located on processing system 159. Memory 147 is preferably digital.

In an embodiment of the invention a first digital camera 100 is configured to transfer data (such as image data), using wireless transmitter 140 to receiver 150. Wherein receiver 150 is coupled to a second digital camera 100. This embodiment is illustrated in FIG. 8 wherein the second digital camera 100 is labeled “100* ”. In second digital camera 100* wireless transmitter 140 acts to serve the function of receiver 150. In various embodiments the data transferred between digital cameras 100 includes image data, any of the data stored in memory 147, or the like. Data transfer can include infrared, microwave, radio, or any other wireless communication medium. Data transfer is optionally controlled by controls 130. In other embodiments, that do not require wireless transmitter 140 and receiver 150, transfer of image data can be accomplished through an electronic coupling. For example, through electronics coupled to both first and second digital cameras 100. This coupling electronics is, in an embodiment, a wire coupled to both digital cameras 100.

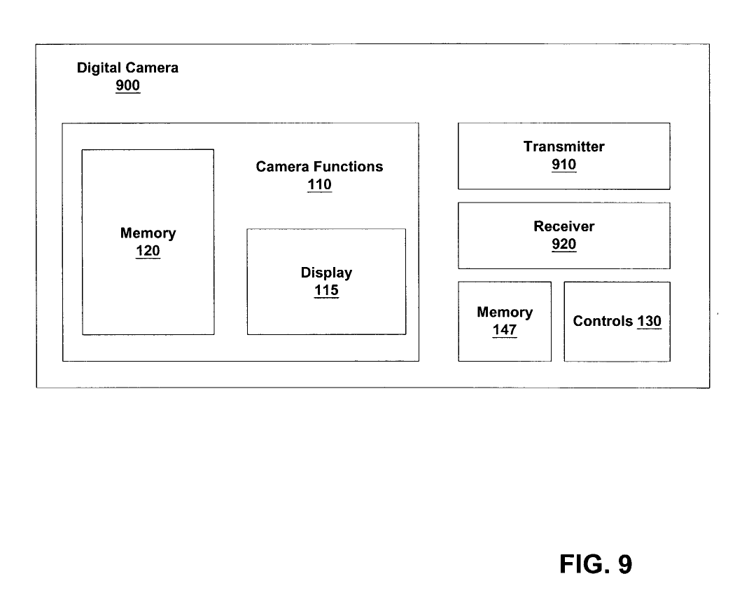

FIG. 9 illustrates an embodiment of the invention including a transmitting digital camera 900 configured to transfer data to a second digital camera 900. Digital camera 900 has a transmitter 910 and an optional receiver 920. Transmitter 910 is configured to transmit data and receiver 920 is configured to receive data. The data transmitted and received is stored in memory 120 or memory 147. Transmitter 910 and receiver 920 are optionally the same device configured to both transmit and receive data. Transmitter 910 and receiver 920 are responsive to controls 130, which are used to initiate transmission and reception.

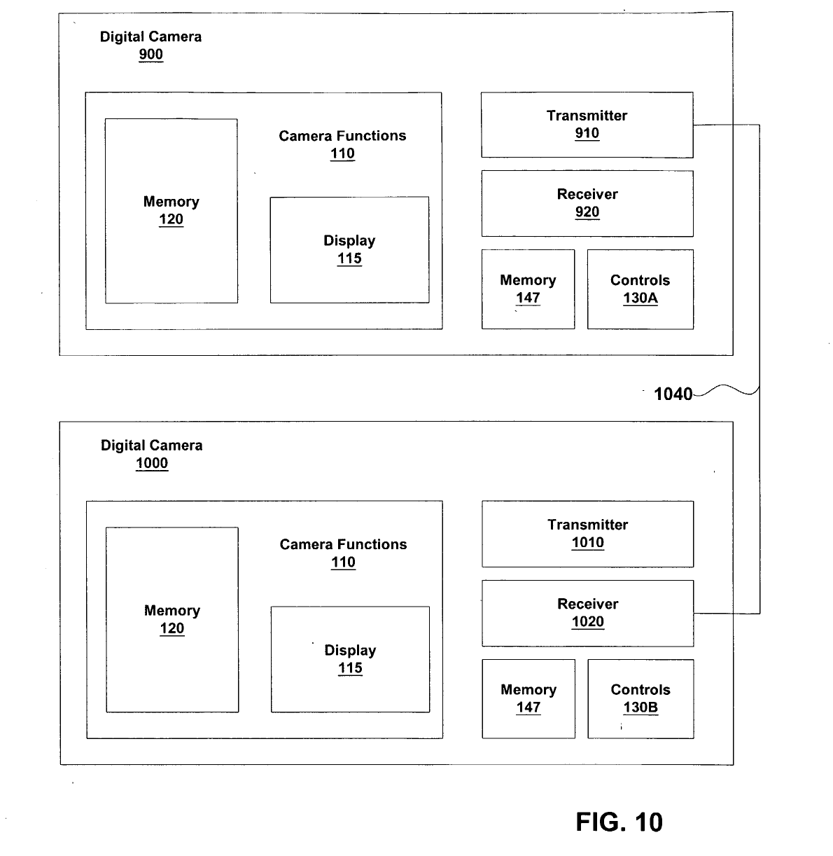

FIG. 10 illustrates transmitting digital camera 900 and receiving digital camera 1000. Receiving digital camera 1000 is configured to receive data from transmitting digital camera 900. Digital camera 1000 has a receiver 1020 and an optional transmitter 1010. Transmitter 1010 is configured to transmit data and receiver 1020 is configured to receive data. The data transmitted and received is stored in memory 120 or memory 147. Transmitter 1010 and receiver 1020 are optionally the same device configured to both transmit and receive data. Transmitter 1010 and receiver 1020 are responsive to controls 130, which can be used to initiate transmission and reception.

During the transfer of data, transmitting digital camera 900 and receiving digital camera 1000 are coupled by a communication means 1040 linking transmitter 910 and receiver 1020. Communication means 1040 is optionally an electromagnetic communication method such as an IR (infrared) or an RF (radio frequency) link. Communication means 1040 is alternatively an electronic link such as wire, cable, or other conductor. In one embodiment communication means 1040 uses a standard interface such as a USB (universal serial bus), serial port, parallel port, J-12, J-45, PCMCI port, or the like.

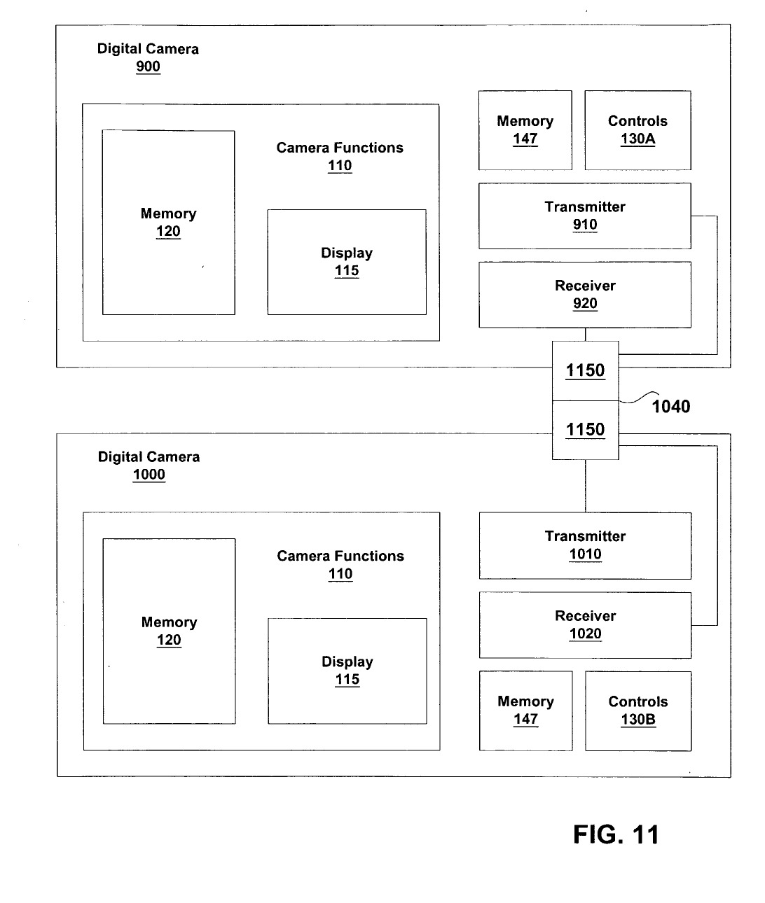

FIG. 11 illustrates embodiments of digital camera 900 and digital camera 1000 each including a built in connector 1150 configured to serve the functions of communications means 1040. In one embodiment connector 1150 is a flip-out or pop-out plug in combination with a receptacle. Connector 1150 is configured to couple to another connector 1150, and is an embodiment of communications means 1040.

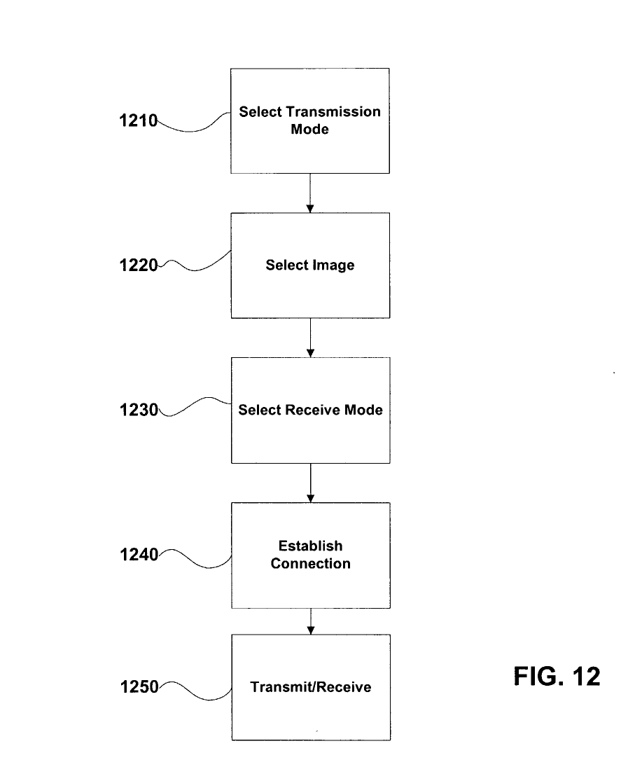

FIG. 12 illustrates an embodiment of a method of the invention in which data is transferred from digital camera 900 to digital camera 1000. In a select transmission mode step 1210, digital camera 900 is set in a transmission mode using controls 130A. The transmission mode configures camera 900 for the transmission of data.

In a select image step 1220, one or more previously recorded images is selected. The selection optionally includes viewing images, stored in memory 120, using display 115. One embodiment of the selection process includes using controls 130A to view stored images one or several at a time and selecting one or more to be transmitted. An alternative embodiment includes selecting all stored images at once using controls 130A. The amount of memory required to store the selected images and/or the amount of time required for transfer are optionally shown on display 115. In one embodiment of the method all stored images are automatically selected and step 1220 is optional.

In a select receive mode step 1230, digital camera 1000 is set in a receive mode using controls 1030. In this step display 115 of digital camera 1000 optionally shows the amount of memory available for storing the received data.

In an establish connection step 1240, a connection for data transfer is established between transmitter 910 and receiver 1020. This connection typically also uses receiver 920 and transmitter 1010 for handshaking. The connection uses communication means 1040 or connector 1150.

In a transmit/receive step 1250, image data is transferred, using the connection established in step 1240, from digital camera 900 to digital camera 1000.

The steps illustrated in FIG. 12 are optionally performed in a variety of orders. For example, select transmission mode step 1210, select image step 1220, select receive mode step 1230, all optionally occur anytime before transmit/receive step 1250. Establish connection step 1240 optionally accomplishes step 1210 or step 1230 automatically. For example, in one embodiment the establishment of the connection automatically sets digital camera 1000 in receive mode. In one embodiment digital camera 900 is simultaneously in transmit and receive modes. Memory 147 is optional in digital camera 900 and digital camera 1000.

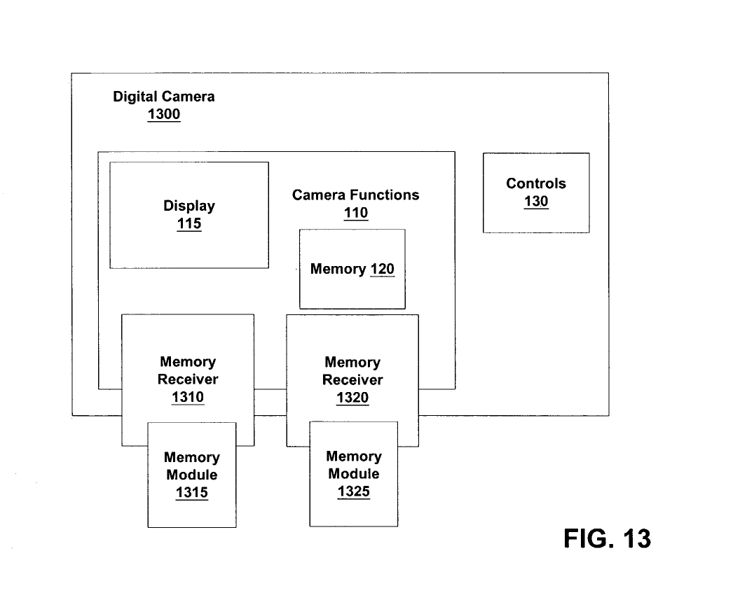

FIG. 13 illustrates an alternative embodiment of the invention including digital camera 1300. In digital camera 1300 a transmitter is optional, however digital camera 1300 must include at least a memory receiver 1310 configured to receive a memory module 1315, and a second memory location which is either memory 120 or a memory receiver 1320 configured to receive a memory module 1325. A unique feature of digital camera 1300 is that it includes a plurality of separable memory locations. The presence of more than one memory location provides an advantage because more memory is available for storing images. Memory module 1315 and memory module 1325 are data storage devices such as a memory stick, RAM, magnetic media (tape or disk), optical media (CD-RW Read/Write), or the like.

Images recorded using camera functions 110 are stored in memory module 1315, optional memory module 1325, or optional memory 120. The location of image storage is responsive to controls 130.

In one embodiment of digital camera 1300 memory module 1315 is attached to digital memory receiver 1310 after images have been stored in memory module 1315. For example, memory module 1315 may contain images recorded using another device, such as a digital camera 100 (See FIG. 1), before coupling to digital camera 1300. In this embodiment it is a feature of digital camera 1300 to be able to display the images previously stored in memory module 1315 using display 115. In this embodiment it is also a feature of digital camera 1300 to be able to transfer images from memory module 1315 to memory module 1325 or memory 120. In one embodiment digital camera 1300 serves the function of an image transfer (copying) device. In this embodiment digital camera 1300 copies or transfers images from memory module 1315 to memory module 1325 or memory 120.

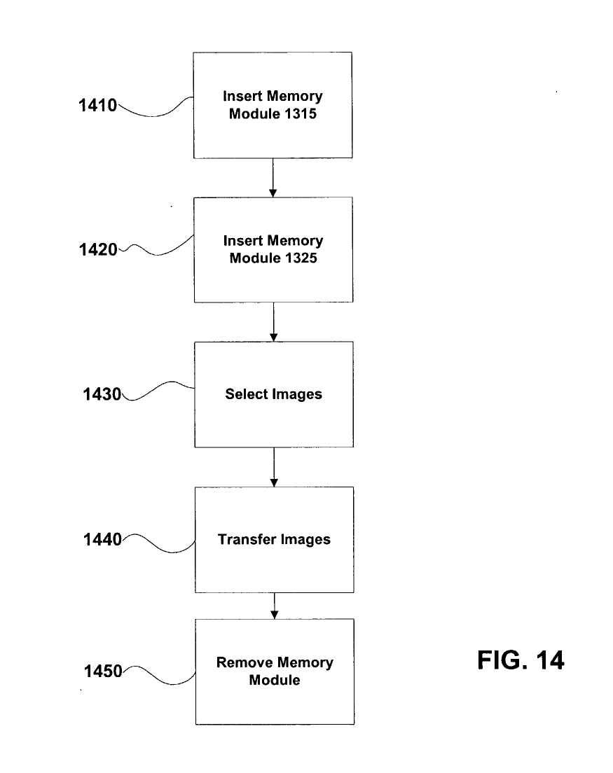

FIG. 14 illustrates a method of the invention using the embodiment of the invention wherein digital camera 1300 serves the function of an image transfer or copying device. In an insert memory step 1410, memory module 1315 is inserted into memory receiver 1310. For the purposes of this example it is assumed that memory module 1315 includes one or more previously recorded images. In an optional insert memory module step 1420, memory module 1325 is inserted into memory receiver 1320. In a select image step 1430 one or more image stored in memory module 1315 is viewed using display 115. The viewing is responsive to controls 130. During the display process a viewed image is selected, using controls 130, for transfer. In an alternative method, all images stored in memory module 1315 are selected by default and step 1430 becomes optional. In a transfer image step 1440, controls 130 are used to initiate (execute) the transfer of the image or images, selected in step 1430, from memory module 1315 to either memory module 1325 or memory 120. The destination of the transfer is dependent on a setting of controls 130 or the presence of memory module 1325. Step 1440 optionally includes the selection of a destination for the transfer. In an optional remove memory step 1450, memory module 1315 and/or memory module 1325 is removed from digital camera 1300.

The steps illustrated in FIG. 14 are optionally performed in a variety of orders to effect the transfer of images. In an alternative embodiment a similar method is used to transfer image data from memory 120 to memory module 1315 or memory module 1325.

As one possible result of the method illustrated in FIG. 14 images are copied from memory module 1315 to memory module 1325. This result provides the ability to reproduce and share images. In another possible result of the method described herein, images are copied from memory 120 to memory module 1325 or memory module 1315. This result also provides the ability to reproduce and share images.

Following step 1450, memory module 1325 or memory module 1315 is optionally inserted in another device for viewing of the transferred images.

Images are comprised of image data.

In selected embodiments the function and operation of a cellular telephone can be replaced by a personal digital assistant with wireless transmission capabilities.

In this disclosure and claims, the terms “transfer” and “transmit” or their derivatives are may be equivalent when transference is done through transmission. Images include image data and image data includes images. Also, in this disclosure and claims, the term “automatically” is meant to mean that something is done without the need for further input from a user.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and though which these teachings have advanced the art, are considered to be within the spirit and scope of the present invention. Hence, these descriptions and drawings should not be considered in a limiting sense, as it is understood that the present invention is in no way limited to only the embodiment illustrated.

I claim:

1. An image processing system comprising:
a microprocessor;
a memory receiver configured to receive a memory for storing image data, the memory being attachable to a digital camera; and
digital data storage,
the image processing system configured to receive the image data from the memory, associate the image data with a user using user identification data, and process the image data using the microprocessor and associated preferred image processing preferences.

2. The image processing system of claim 1, wherein the memory includes image memory and user identification memory.

3. The image processing system of claim 1, wherein the memory includes the preferred image processing preferences.

4. The image processing system of claim 3, wherein the preferred image processing preferences are programmed into the memory using the digital camera having controls for entering the preferred image processing preferences.

5. A method of processing an image comprising the steps of:
recording image data using a digital camera;
saving the image data to memory attached to the digital camera;
detaching the memory from the digital camera;
conveying the memory to an image processing system including a digital data storage;
attaching the memory to the image processing system;
transferring the image data from the memory to the digital storage;
associating the image data with a user; and
processing the image data according to preferred image processing preferences.

6. The method of claim 5, further including a step of storing the preferred image processing preferences in the memory using the digital camera.

7. The method of claim 5, further including a step of storing user identifying data in the memory using the digital camera.

8. The method of claim 5, further including a step of delivering the preferred image processing preferences to the processing system using a computer network or a telephone network.

9. The method of claim 5, further including a step of delivering the processed image data to a user using the internet.

10. An image transfer system comprising:
a first digital camera including a wireless transmitter configured to transmit image data and including controls configured to select the image data from a plurality of image data and to initiate the transfer of the image data; and
a second digital camera including a wireless receiver configured to receive and display the image data.

11. The image transfer system of claim 10, wherein the wireless transmitter is an IR transmitter.

12. The image transfer system of claim 10, wherein the wireless transmitter is compatible with a cellular telephone network.

13. The image transfer system of claim 12, wherein the second digital camera is addressable using a telephone number.

14. The image transfer system of claim 13, wherein the second digital camera is addressable using a telephone number extension.

15. The image transfer system of claim 10, wherein the second digital camera is addressable using a camera identification number.

16. The image transfer system of claim 10, further including an image processing system configured to receive the image data from the first digital camera and to deliver the image data to the second digital camera.

17. The image transfer system of claim 16, wherein the image processing system includes digital data storage configured to store a copy of the digital data.

18. A method of producing a digital image, the method comprising the steps of:
recording image data using a first digital camera;
viewing the recorded image data on a display connected to the first digital camera;
selecting the image data, from among a plurality of image data, for transmission from the first digital camera;
entering address data into the first digital camera;
transmitting the selected image data using a wireless transmitter and the address data;
receiving the selected image data at a second digital camera using a wireless receiver; and
displaying the received image data at the second digital camera.

19. The method of claim 18, wherein the address data is a camera identification number

20. The method of claim 18, wherein the address data includes a telephone number and a telephone number extension.

21. The method of claim 18, further including the steps of receiving the transmitted image data at an image processing system and transferring the transmitted image data from the image processing system to the second digital camera using a wireless transmitter.

22. The method of claim 21 further including the steps of
storing the transmitted image data at the image processing,
viewing the stored image data and
selecting the viewed digital image for transfer to the second digital camera.

23. The method of claim 18, wherein the wireless transmitter is an IR transmitter.

24. The method of claim 18, further including the step of wherein the image is transmitted responsive to a time of day.

25. A method of transferring image data comprising the steps of:
recording image data using a first digital camera including a display;
setting the first digital camera in a transmission mode;
viewing the image data using the display;
selecting a viewed image data for transfer;
setting a second digital camera in a receive mode;
establishing a communication means between the first digital camera and the second digital camera; and
executing a transfer of the selected image from the first digital camera to the second digital camera using the established electronic communication means.

26. The method of claim 25, wherein the communication means includes an electrical connection.

27. The method of claim 26, wherein the step of establishing a communication means includes plugging the first digital camera into the second digital camera.

28. The method of claim 25, wherein the communication means includes a fiber optic.

29. A system for transferring image data, the system comprising:
a first digital camera including camera controls, a display and a transmission mode, the first digital camera configured to record image data, view the recorded image data using the display, select a viewed image for transfer using the camera controls, and transfer the image data using the transmission mode;
a second digital camera including a receive mode and a receiver configured to receive the image data using the receive mode; and
means for transfer the digital data between the first digital camera and the second digital camera.

30. The method of claim 29, wherein the means for transferring includes an electrical connection.

31. The method of claim 29, wherein the means for transferring includes a fiber optic.

32. The method of claim 29, wherein the first digital camera further includes a plug and the second digital camera further includes a receptacle configured to receive the plug.

33. A system of transferring image data comprising:
a first detachable memory module configured to store image data; and
a digital camera including a second memory module configured to store image data, a memory receiver configured to receive the first detachable memory module, camera controls configured to select image data for transfer between the first detachable memory module and the second memory module and to initiate the transfer, and a display configured to view image data stored in the first detachable memory module or the second memory module.

34. The system of claim 33, wherein the second memory module is detachable and the digital camera includes a second memory receiver configured to receive the second memory module.

35. The system of claim 34, wherein the digital camera includes a third memory module.

36. The system of claim 33, wherein the first detachable memory module is further configured to store user identifying data.

37. The system of claim 33, wherein the first detachable memory module is further configured to store preferred image processing preferences.

38. The system of claim 33, further including an image processing system configured to receive the first detachable memory module.

39. A method of copying image data comprising the steps of:
recording image data using a digital camera, the digital camera including a plurality of memory configured to store then image, at least one of the plurality of memory being separable from the digital camera;
viewing the image data using a display coupled to the digital camera;
selecting the viewed image data for transfer from a first member of the plurality of memory to a second member of the plurality of memory; and
operating controls to initiate the transfer of the selected image data from the first member of the plurality of memory to the second member of the plurality of memory.

40. The method of claim 39, further including the step of detaching the second member of the plurality of memory from the camera.

41. The method of claim 39, wherein the first member of the plurality of memory is separable from the digital camera.

42. The method of claim 39, further including a step of attaching the second member of the plurality of memory to a another digital camera.

43. The method of claim 39, further including a step of attaching the second member of the plurality of memory to an image processing system.

44. The method of claim 39, further including a step of transferring user identifying data to the second member of the plurality of memory.

45. The method of claim 39, further including a step of transferring preferred image processing preferences to the second member of the plurality of memory.

46. A method of copying image data comprising the steps of:
saving image data in a first detachable memory module;
attaching the detachable memory module to a digital camera, the digital camera including a second memory module configured to store the image data; and
operating camera controls to initiate the transfer of the image data from the first detachable memory module to the second memory module.

47. The method of claim 46, further including steps of viewing the image data using a display coupled to the digital camera and selecting the viewed image data for transfer from the first detachable memory module to the second memory module.

48. The method of claim 44, wherein the second memory module is detachable.

49. The method of claim 44, wherein another digital camera is used to perform the step of saving image data in a first detachable memory module.

50. An image transfer system comprising:
a digital camera including a first memory module and a memory receiver configured to receive a second detachable memory module; and
means for transferring image data between the first memory module and the second memory module.

51. The image transfer system of claim 50, wherein the first memory module is detachable.

52. The image transfer system of claim 50, wherein the second detachable memory module is configured to store user identifying data.
